(19) United States
(12) Patent Application Publication
(10) Pub. No.: US 2026/0062027 A1
(43) Pub. Date: Mar. 5, 2026

(54) VEHICLE NOTIFICATION DEVICE

(71) Applicant: HONDA MOTOR CO., LTD., Tokyo (JP)

(72) Inventors: Shohei Kamochi, Tokyo (JP); Naoki Kikuchi, Tokyo (JP); Shogo Usui, Tokyo (JP); Akira Sakata, Tokyo (JP); Ko Endo, Tokyo (JP); Masaki Nara, Tokyo (JP); Yoshiyuki Uwamino, Tokyo (JP)

(21) Appl. No.: 19/296,247

(22) Filed: Aug. 11, 2025

(30) Foreign Application Priority Data
Aug. 27, 2024 (JP) 2024-145908

(51) Int. Cl. B60W 50/14; B60W 40/08; B60W 50/00

(52) U.S. Cl. CPC B60W 50/14; B60W 40/08; B60W 2040/0809; B60W 2050/0083; B60W 2050/146; B60W 2540/043

(57) ABSTRACT

A vehicle notification device includes: a modification unit that modifies a setting of specific equipment that is equipment specifically determined in advance among equipment provided in a vehicle; and a notification unit that, when a setting of the specific equipment is modified, gives an occupant of the vehicle a notification urging to modify a setting of relevant equipment that is the equipment related to the specific equipment.

### INCORPORATION BY REFERENCE

The present application claims priority under 35 U.S.C. § 119 to Japanese Patent Application No. 2024-145908 filed on Aug. 27, 2024. The content of the application is incorporated herein by reference in its entirety.

### BACKGROUND OF THE INVENTION

### Field of the Invention

The present invention relates to a vehicle notification device.

### Description of the Related Art

In recent years, there have been increasing efforts to provide access to sustainable transportation systems that take into consideration people in vulnerable positions such as the elderly, people with disabilities, and children among traffic participants. In order to achieve this, attention is given to research and development for further improving traffic safety and convenience through development relating to comfortable cabins of vehicles.

As one development relating to comfortable cabins of vehicles, Japanese Patent Laid-Open No. 2020-083204 discloses a vehicle including: a seat that is installed in the cabin and configured to be at least partially movable; a projection device capable of projecting an image onto a wall surface in the cabin; and a control unit that acquires the state of the seat, controls the projection position of the projection device, and modifies the projection position of the projection device according to the state of the seat.

A vehicle is provided with specific equipment and relevant equipment for which modification of a setting may be required along with modification of a setting of the specific equipment like the seat and the projection device described in Japanese Patent Laid-Open No. 2020-083204. However, there is a concern that an occupant may forget to modify the setting of relevant equipment in accordance with the modification of the setting of the specific equipment.

In order to solve the problem, the purpose of the present application is to prevent the occupant from forgetting to modify the setting of the relevant equipment along with the modification of the setting of the specific equipment. This will contribute to development of sustainable transport systems.

### SUMMARY OF THE INVENTION

One aspect of the present invention is a vehicle notification device including: a modification unit that modifies a setting of specific equipment that is equipment specifically determined in advance among equipment provided in a vehicle; and a notification unit that, when a setting of the specific equipment is modified, gives an occupant of the vehicle a notification urging to modify a setting of relevant equipment that is the equipment related to the specific equipment.

According to the one aspect of the present invention, it is possible to prevent the occupant from forgetting to modify the setting of the relevant equipment along with the modification of the setting of the specific equipment.

### BRIEF DESCRIPTION OF THE DRAWINGS

FIG. 1 is a diagram showing a configuration of a vehicle;

FIG. 2 is a diagram showing a configuration of a vehicle notification device provided in the vehicle;

FIG. 3 is a diagram showing a configuration of occupant information DB;

FIG. 4 is a diagram showing an example of an operation screen;

FIG. 5 is a diagram showing an example of a modification recommendation screen;

FIG. 6 is a diagram showing an example of a second modification recommendation screen; and

FIG. 7 is a flowchart showing an operation of the vehicle notification device.

### DETAILED DESCRIPTION OF THE INVENTION

### Embodiment

### 1. Configuration

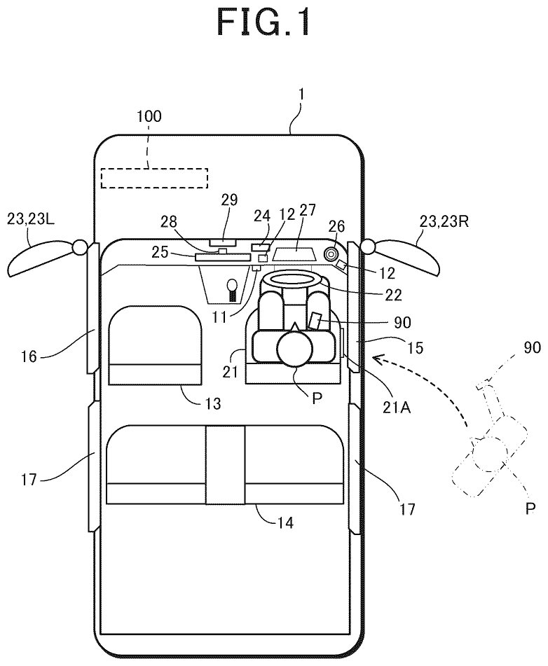

A configuration of a vehicle 1 of the present embodiment will be described with reference to FIG. 1.

FIG. 1 is a diagram showing the configuration of the vehicle 1.

The vehicle 1 shown as an example in FIG. 1 is a four-wheel vehicle.

The vehicle 1 includes a driving seat 21, a passenger seat 13, and a rear seat 14. FIG. 1 shows a situation in which an occupant P who is a driver is seated in the driver's seat.

The vehicle 1 has a right front door 15, a left front door 16, and two rear doors 17. Opening the right front door 15, the left front door 16, and the two rear doors 17 allows entry and exit from a cabin space of the vehicle 1.

The vehicle 1 includes a vehicle notification device 100 that, when a setting of the driving seat 21 is modified, gives a notification urging to modify a setting of equipment related to the driving seat 21.

The driving seat 21 is configured to be able to modify settings such as the up-and-down position and fore-and-aft position of a seat surface, and the angle of a backrest. The driving seat 21 is a seat in which the occupant P who drives the vehicle 1 sits, and can also be referred to as an electric seat or a driver seat. The driving seat 21 corresponds to an example of “specific equipment”.

The driving seat 21 has a seat operating device 21A that is operated by the occupant P to modify the settings of the driving seat 21. The seat operating device 21A may be a switch or a lever. The seat operating device 21A corresponds to an example of an “operating device”.

The vehicle 1 includes a steering wheel 22, a side mirror 23, a head-up display (HUD) 24, a rearview mirror 29, a louver 12, and a meter 27 as examples of relevant equipment subjected to deterioration in functionality for the occupant P as the settings of the driving seat 21 are modified. The steering wheel 22, the side mirror 23, the HUD 24, the rearview mirror 29, the louver 12, and the meter 27 correspond to examples of the “relevant equipment”.

When the positional relationship between the steering wheel 22 and the driving seat 21 is not appropriate, the operability of the steering wheel 22 by the occupant P is decreased. In particular, the steering wheel 22 is equipment for steering the vehicle 1 when the vehicle 1 is traveling. The steering wheel 22 corresponds to an example of “specific relevant equipment” related to the traveling of the vehicle 1 driven by the occupant P.

When the positional relationship between the side mirror 23 and the driving seat 21 is not appropriate, the visibility of an external situation of the vehicle from the occupant P is decreased. In particular, the side mirror 23 is equipment for confirming the external situation of the vehicle when the vehicle 1 is traveling. The side mirror 23 corresponds to an example of “specific relevant equipment” that is specific equipment related to the traveling of the vehicle 1 driven by the occupant P.

Note that, when the positional relationship between the HUD 24 and the driving seat 21 is not appropriate, it becomes difficult for the occupant P to see the display of the HUD 24.

Moreover, when the positional relationship between the rearview mirror 29 and the driving seat 21 is not appropriate, visibility to the rear side of the cabin space and the outside area behind the vehicle is decreased.

Further, when the positional relationship between the louver 12 and the driving seat 21 is not appropriate, the air hits an undesired part of the body of occupant P, thereby decreasing comfort.

The vehicle 1 includes a speaker 26 and a touch panel 25 of display audio (DA) or the like. The speaker 26 corresponds to an example of “notification means”. The touch panel 25 corresponds to an example of “display means”.

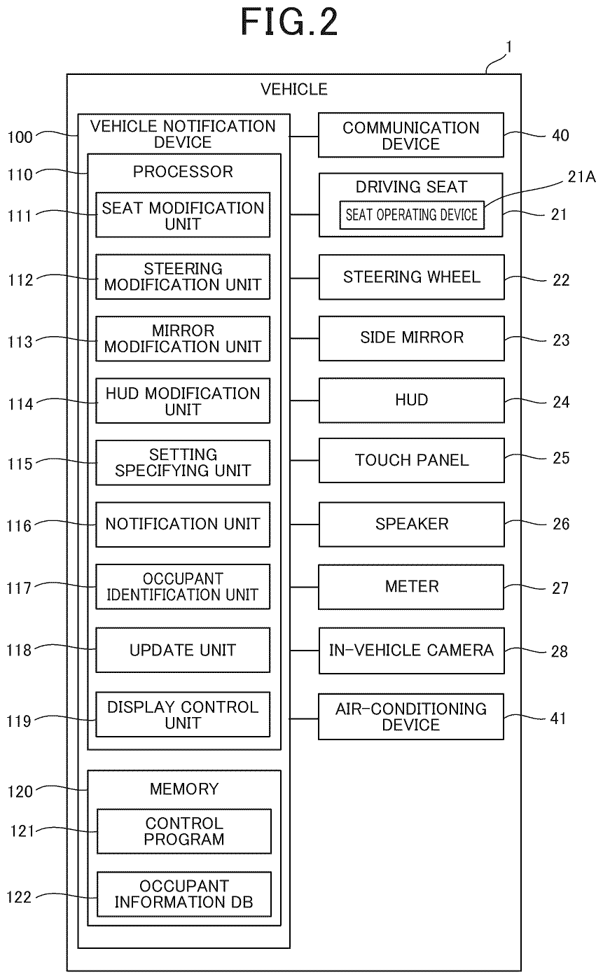

FIG. 2 is a diagram showing the configuration of the vehicle notification device 100.

The vehicle notification device 100 is connected to a communication device 40, the driving seat 21, the side mirror 23, the HUD 24, the touch panel 25, the speaker 26, the meter 27, an in-vehicle camera 28, and an air-conditioning device 41. Note that the devices connected to the vehicle notification device 100 are not limited to these devices, and other types of devices may also be connected.

The communication device 40 is communication means including a transmitter, a receiver, and a control unit that controls communication. As shown in FIG. 1, the communication device 40 executes communication with a mobile communication terminal 90 carried by the occupant P.

The HUD 24 and the touch panel 25 display various types of information, according to control by the vehicle notification device 100.

The speaker 26 outputs various types of voices, according to control by the vehicle notification device 100.

The in-vehicle camera 28 captures an image of a range of the cabin space, including at least a part of the occupant P, according to control by the vehicle notification device 100, and outputs the captured image to the vehicle notification device 100.

The air-conditioning device 41 is a device that includes a compressor, a condenser, an evaporator, a four-way valve and a control unit that controls the air-conditioning of the air-conditioning device 41, and performs air conditioning in the cabin space. The air that has been heat-exchanged by the air-conditioning device 41 is caused to flow into the cabin space from the louver 12.

The vehicle notification device 100 includes a processor 110, such as a central processing unit (CPU) and a microprocessor unit (MPU), a memory 120, and an interface circuit for connecting to other devices and sensors. The memory 120 corresponds to an example of a “storage unit”.

The memory 120 is a storage device for storing a program and data. The memory 120 stores a control program 121, an occupant information database (DB) 122, and data to be processed by the processor 110. The memory 120 has a non-volatile storage area. The memory 120 may also include a volatile storage area to form a work area for the processor 110. The memory 120 is constituted by, for example, a read-only memory (ROM) and a random access memory (RAM).

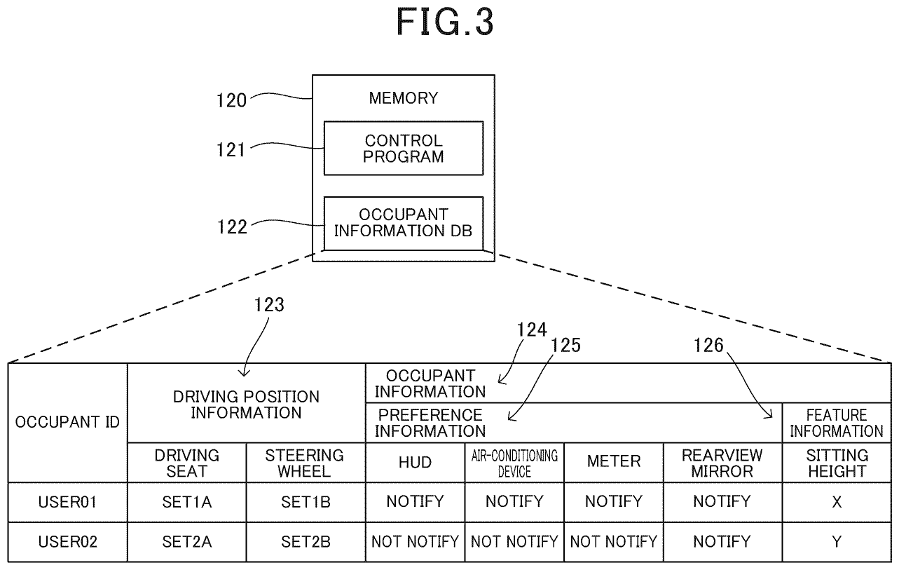

FIG. 3 is a diagram showing the configuration of the occupant information DB 122.

In the occupant information DB 122, driving position information 123 and occupant information 124 are recorded for each specific occupant P registered in the vehicle 1. The specific occupant P is the owner of the vehicle 1, a co-owner who shares the vehicle 1 with the owner to use the vehicle 1, or the like. A specific occupant P corresponds to an example of the “specific occupant”.

The driving position information 123 includes information about the settings of the driving seat 21 and the steering wheel 22 for each occupant ID (identifier) that uniquely identifies a specific occupant P. The information about the settings of the driving seat 21 and the steering wheel 22 is predetermined by the occupant P.

The occupant information 124 includes preference information 125 indicating preferences of the occupant P, and feature information 126 indicating the physical features of the occupant P.

The preferences of the occupant P are the preferences of the occupant P about settings of relevant equipment, such as, for example, whether or not the occupant P often looks at the HUD 24 while the vehicle 1 is traveling, whether or not the occupant P cares about the air from the air-conditioning device 41 hits the face, whether or not the occupant P cares about flickering of the meter 27, and whether or not the occupant P often adjusts the rearview mirror 29. The preference information 125 is prerecorded in the occupant information DB 122 by presetting by the occupant P. In the present embodiment, according to the preferences of the occupant P, for each piece of equipment, whether or not a later-described notification unit 116 gives a notification to urge to modify a setting when a setting of the driving seat 21 is modified is recorded as the preference information 125 in the occupant information DB 122.

The physical feature of the occupant P is the physique of the occupant P. The physique of the occupant P is the sitting height of the occupant P. The feature information 126 includes a numerical value of the sitting height of the occupant P as information about the physique of the occupant P. The information about the physique of the occupant P is prerecorded in the occupant information DB 122 by, for example, a measurement taken in advance from the image captured by the in-vehicle camera 28, and pre-settings made by the occupant P.

The processor 110 functions as a seat modification unit 111, a steering modification unit 112, a mirror modification unit 113, an HUD modification unit 114, a setting specifying unit 115, a notification unit 116, an occupant identification unit 117, an update unit 118, and a display control unit 119 by reading and executing the control program 121 stored in the memory 120.

The seat modification unit 111 modifies the position setting of the driving seat 21, according to an operation of the seat operating device 21A operated by the occupant P to modify the setting of the driving seat 21, or an input via the touch panel 25.

The seat modification unit 111 controls the driving of an electric motor (not shown) of the driving seat 21 to modify the angle of the backrest and the fore-and-aft position of the seat surface of the driving seat 21.

The seat modification unit 111 also functions as a functional unit that detects an operation performed by the occupant P who gives an instruction to modify the setting of the driving seat 21. The seat modification unit 111 corresponds to an example of the “modification unit”.

The steering modification unit 112 modifies the position setting of the steering wheel 22, according to an input via the touch panel 25 operated by the occupant P to modify the setting of the steering wheel 22.

The steering modification unit 112 modifies the settings of the fore-and-aft position and height of the steering wheel 22 by controlling the driving of an adjustment mechanism (not shown) of the steering wheel 22. The adjustment mechanism may be a so-called tilt mechanism or a so-called telescopic mechanism.

Upon an instruction to modify the setting corresponding to the driving position information 123, the seat modification unit 111 and the steering modification unit 112 modify the driving seat 21 and the steering wheel 22 to the settings corresponding to the driving position information 123, according to the instruction. The settings corresponding to the driving position information 123 are the position settings of the driving seat 21 and the steering wheel 22 determined in advance for the specific occupant P as shown in FIG. 3.

The setting instructions corresponding to the driving position information 123 will be described in detail later, but are transmitted from the occupant identification unit 117 when the occupant identification unit 117 identifies that the specific occupant P enters the vehicle 1.

The mirror modification unit 113 modifies the position setting of the side mirror 23, according to an input via the touch panel 25 operated by the occupant P to modify the setting of the side mirror 23. The mirror modification unit 113 modifies the settings of the angles in the up-down, left-right, and front-rear directions of the side mirror 23 by controlling the driving of an electric motor (not shown) connected to the side mirror 23.

The HUD modification unit 114 modifies the settings of the HUD 24, according to an input via the touch panel 25 operated by the occupant P to modify the settings of the HUD 24. The HUD modification unit 114 modifies the settings of the height and the illumination angle of the HUD 24 by controlling the driving of an electric motor (not shown) provided in the HUD 24. Moreover, the HUD modification unit 114 modifies the setting of display brightness of the HUD 24 by controlling the brightness of a light-emitting part (not shown) provided in the HUD 24.

The setting specifying unit 115 specifies recommended settings and second recommended settings for the steering wheel 22 and the side mirror 23 corresponding to the settings of the driving seat 21, based on the occupant information 124 about the occupant P identified by the occupant identification unit 117 and the degree of modification of the settings of the driving seat 21 made by the seat modification unit 111. The recommended settings and the second recommended settings are prestored in the memory 120.

The degree of modification of the settings of the driving seat 21 made by the seat modification unit 111 is, for example, modification values indicating how much the angle of the backrest of the driving seat 21 has been changed and how much the fore-and-aft or height position of the seat surface has been changed by the seat modification unit 111.

The recommended settings are settings that are recommended, in conjunction with the modification of the settings of the driving seat 21, for the setting of specific relevant equipment related to the traveling of the vehicle 1 driven by the occupant P.

For example, a case in which a setting is modified to recline the backrest of the driving seat 21 will be described. In this case, since the distance between the occupant P and the steering wheel 22 increases, lowering the steering wheel 22 to bring the steering wheel 22 closer to the occupant P is a recommended setting.

Moreover, in this case, for example, since the eye position of the occupant P is shifted downward, modifying the angle of the side mirror 23 on the driving seat 21 side downward is a recommended setting.

Thus, from the aspect of preventing deterioration in functionality of relevant equipment for the occupant P, according to the modification of the position setting of the driving seat 21, the recommended settings are appropriately determined in advance based on the relationship between the information about the physique of the occupant P shown by the feature information 126 included in the occupant information 124 and the degree of modification of the settings of the driving seat 21.

Further, when the occupant P is a specific occupant P recorded in the occupant information DB 122, if the HUD 24 is to be notified by the notification unit 116 based on the preference information of the occupant P indicated by the preference information 125 included in the occupant information 124, the setting specifying unit 115 specifies the second recommended setting for the HUD 24. The second recommended setting corresponds to an example of the “recommended settings”.

For example, when the setting is modified to recline the backrest of the driving seat 21, the eye position of the occupant P shifts downward, and, therefore, shifting the illumination angle of the HUD 24 upward or raising the height of the HUD 24 is the second recommended setting.

When the setting specifying unit 115 specifies the recommended setting and the second recommended setting, the setting specifying unit 115 generates recommended setting information indicating information about the specified recommended setting and second recommended setting, and outputs the information to the notification unit 116.

When the seat modification unit 111 detects a modification in the setting of the driving seat 21, the notification unit 116 causes the display control unit 119 to display a modification recommendation screen G2 and a second modification recommendation screen G3 as will be described later, thereby giving the occupant P a notification urging to modify the settings of relevant equipment that may be subjected to deterioration in functionality due to the modification of the setting of the driving seat 21.

Moreover, when the setting of the driving seat 21 is modified by means other than the touch panel 25 that mainly provides notifications, the notification unit 116 changes the content of the notification from that when the setting of the driving seat 21 is modified via the touch panel 25.

More specifically, when the setting of the driving seat 21 is modified through the seat operating device 21A provided to the driving seat 21, the notification unit 116 outputs, via the speaker 26, a voice providing a notification to urge the occupant P to look at the touch panel 25 and ultimately urge the occupant P to modify the settings of relevant equipment. The voice may read out, for example, a text “Look at the touch panel and modify other settings”. Thus, when the occupant P modifies the setting of the driving seat 21 via the seat operating device 21A, there is a high possibility that the occupant P is not looking in the direction of the touch panel 25, but the notification by voice output facilitates conveying a later-described notification by means of a screen display to the occupant P.

The occupant identification unit 117 identifies and authenticates whether the occupant P is a specific occupant P, based on key information transmitted from the mobile communication terminal 90 carried by the occupant P. The key information is information indicating that the mobile communication terminal 90 is linked to the specific occupant ID.

As shown in FIG. 1, the occupant identification unit 117 recognizes, through communication between the communication device 40 and the mobile communication terminal 90, that the specific occupant P enters the vehicle 1. In FIG. 1, a two-dot-and-dash line indicates a state in which the specific occupant P carrying the mobile communication terminal 90 approaches the vehicle 1 to enter the vehicle 1. For example, if the vehicle 1 is locked, when the occupant identification unit 117 recognizes a specific occupant P trying to enter the vehicle 1 and then identifies and authenticates the occupant P, an engine control unit (ECU) (not shown) provided in the vehicle 1 unlocks the key to the vehicle 1.

Examples of the mobile communication terminal 90 include a smart key, a key fob, a smartphone, and a smart watch.

When the occupant identification unit 117 identifies the specific occupant P, the occupant identification unit 117 specifies the driving position information 123 and the occupant information 124 of the corresponding occupant P from the occupant information DB 122.

The occupant identification unit 117 corresponds to an example of the “occupant information specifying unit”.

When the occupant identification unit 117 acquires the driving position information 123, the occupant identification unit 117 sends instructions to the seat modification unit 111 and the steering modification unit 112 to set the driving seat 21 and the steering wheel 22 according to the settings indicated by the driving position information 123.

As will be described in detail later, the update unit 118 updates the settings of the driving seat 21 and the steering wheel 22 in the occupant information DB 122 to the current settings of the driving seat 21 and steering wheel 22, according to an input via the touch panel 25.

The display control unit 119 displays a screen, and accepts an input from the occupant P via the touch panel 25.

The display control unit 119 displays an operation screen G1 through which the settings of the driving seat 21, the steering wheel 22, the side mirror 23, and the HUD 24 can be modified.

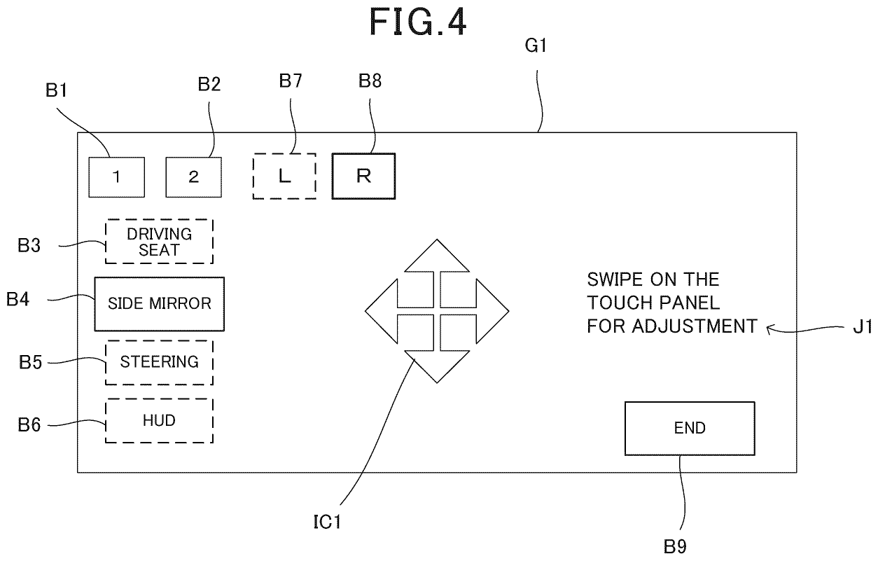

FIG. 4 is a diagram showing an example of the operation screen G1 that the display control unit 119 displays through the touch panel 25. The up-down direction and the left-right directions in the operation screen G1 on the touch panel 25 correspond to the up-down direction and the left-right directions on the drawing.

The operation screen G1 is a screen for accepting an input from the occupant P, thereby accepting an input for modifying the settings of the driving seat 21, the steering wheel 22, the side mirror 23, and the HUD 24.

The operation screen G1 displays, at the upper left, a set button B1 as a software button with a character string “1”, and a set button B2 as a software button with a character string “2”. For example, after modifying the setting of the driving seat 21, when the set button B1 is pressed and then the set button B2 is pressed within a predetermined time (for example, 5 seconds), the update unit 118 updates the driving position information 123 to the modified setting of the driving seat 21. The set button B1 and the set button B2 are a set button and a memory button used in a so-called driving position system for saving the setting of the driving seat 21.

The operation screen G1 displays, on the left, a seat selection button B3 as a software button with a character string “Driving Seat”, a mirror selection button B4 as a software button with a character string “Side Mirror”, a steering selection button B5 as a software button with a character string “Steering”, and an HUD selection button B6 as a software button with a character string “HUD”, in this order from the top.

The seat selection button B3 is a button for switching to a screen that displays an operating device icon as a software button capable of modifying the setting of the driving seat 21 by a predetermined operation (for example, a swipe operation or a flick operation).

The steering selection button B5 is a button for switching to a screen that displays an operating device icon as a software button capable of modifying the setting of the steering wheel 22 by a predetermined operation (for example, a swipe operation or a flick operation).

The HUD selection button B6 is a button for switching to a screen that displays an operating device icon as a software button capable of modifying the setting of the HUD 24 by a predetermined operation (for example, a swipe operation or a flick operation).

The mirror selection button B4 is a button for switching to a screen that displays an operating device icon IC1 as a software button capable of modifying the setting of the side mirror 23 by a predetermined operation (for example, a swipe operation or a flick operation).

The operation screen G1 shown in FIG. 4 indicates a state in which the mirror selection button B4 is selected. In this state, the mirror selection button B4 has a larger frame than other seat selection button B3, steering selection button B5 and HUD selection button B6, and is indicated by a solid line. Consequently, the occupant P can easily recognize that this screen is the operation screen G1 for modifying the setting of the side mirror 23.

Moreover, the operation screen G1 displays a left mirror selection button B7 as a software button with a character string “L” for selecting an operation of a left side mirror 23L, and a right mirror selection button B8 as a software button with a character string “R” for selecting an operation of a right side mirror 23R.

The operation screen G1 shown in FIG. 4 indicates a state in which the right mirror selection button B8 is selected. In this state, the right mirror selection button B8 has a larger frame than the left mirror selection button B7, and is indicated by a solid line. Consequently, the occupant P can easily recognize that this screen is the operation screen G1 for modifying the setting of the right side mirror 23.

Further, the operation screen G1 displays, on the right side of the operating device icon IC1, guidance information J1 indicating how to operate the operating device icon IC1. The guidance information J1 has a character string “Please swipe on the touch panel for adjustment”.

The operation screen G1 displays, at the lower left, an end button B9 as a software button with a character string “End”. When the end button B9 is pressed, the display control unit 119 ends the display of the operation screen G1.

Next, a screen that the display control unit 119 displays when a modification in the setting of the driving seat 21 is detected by the seat modification unit 111 will be described.

The display control unit 119 displays the modification recommendation screen G2 urging to modify the settings of the side mirror 23 and the steering wheel 22. The display control unit 119 generates the modification recommendation screen G2, based particularly on the recommended settings in the recommended setting information.

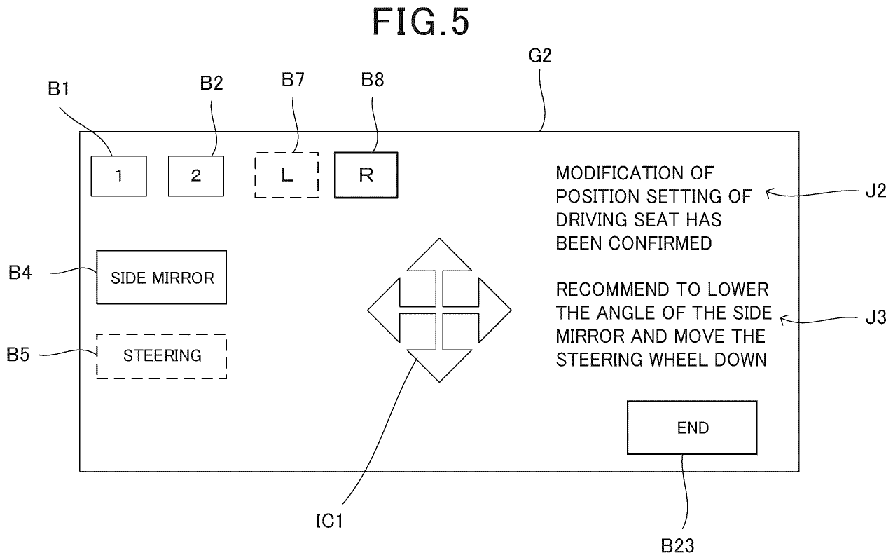

FIG. 5 is a diagram showing an example of the operation screen G2 that the display control unit 119 displays through the touch panel 25. The up-down direction and the left-right directions in the operation screen G2 on the touch panel 25 correspond to the up-down direction and the left-right directions on the drawing.

The modification recommendation screen G2 displays the set button B1, the set button B2, the mirror selection button B4, and the steering selection button B5 similarly to the operation screen G1 of FIG. 4. Moreover, in the example of the modification recommendation screen G2 shown in FIG. 5, the mirror selection button B4 is in the selected state, and the left mirror selection button B7, the right mirror selection button B8, and the control icon IC1 are displayed.

The modification recommendation screen G2 displays, on the right side of the operating device icon IC1, detection information J2 that is information indicating that a modification in the setting of the driving seat 21 has been detected. The detection information J2 includes a character string saying “Modification of the position setting of the driving seat has been confirmed”.

The modification recommendation screen G2 displays, on the right side of the operating device icon IC1, recommendation information J3 indicating recommended settings for the side mirror 23 and steering wheel 22, included in the recommended setting information generated by the setting specifying unit 115. The recommendation information J3 includes a character string saying “Lower the angle of the side mirror and move the steering wheel down”.

The operation screen G2 displays, at the lower right, an end button B23 as a software button with a character string “End”.

When there is no input from the occupant P for a predetermined time via the modification recommendation screen G2, or when the occupant P presses the end button B9, the notification unit 116 ends the display of the modification recommendation screen G2 by the display control unit 119.

Since the modification recommendation screen G2 is displayed when the setting of the driving seat 21 is modified, the display of the modification recommendation screen G2 urges the occupant P to modify the settings of the side mirror 23 and the steering wheel 22 that are subjected to deterioration in functionality due to the modification of the setting of the driving seat 21 and are particularly related to the traveling of the vehicle 1.

The display control unit 119 displays the second modification recommendation screen G3 urging to modify the setting of equipment that is not related to the traveling of the vehicle 1 but is subjected to deterioration in functionality due to the modification of the setting of the driving seat 21. The display control unit 119 generates the second modification recommendation screen G3 based on the preference information 125 and particularly the second recommended setting in the recommended setting information.

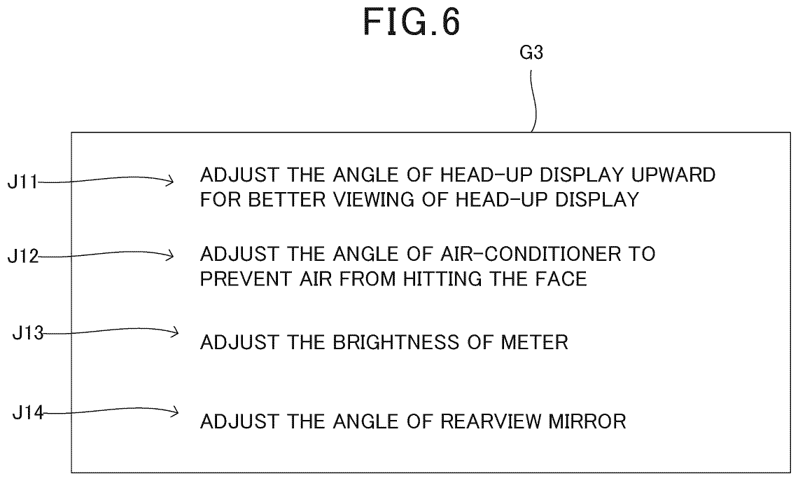

FIG. 6 is a diagram showing an example of the second modification recommendation screen G3 that the display control unit 119 displays through the touch panel 25. The second modification recommendation screen G3 is a screen that is displayed only for a predetermined time upon a predetermined trigger. The predetermined trigger is the end of the display of the modification recommendation screen G2 caused by pressing the end button B23 or an elapse of the predetermined time.

The second modification recommendation screen G3 displays recommendation information J11 that is included in the recommended setting information generated by the setting specifying unit 115 and indicates the second recommended setting for the HUD 24. The recommendation information J11 includes a character string saying “Adjust the angle of head-up display upward for better viewing of head-up display”.

The second modification recommendation screen G3 displays urging information J12 urging to modify the setting of the louver 12, if notifications for the air-conditioning device 41 are enabled, based on the preference information 125 included in the occupant information 124 recorded in the occupant information DB 122. The urging information J12 includes a character string saying “Adjust the angle of air-conditioner to prevent air from hitting the face”. When the notifications for the air-conditioning device 41 are disabled, the second modification recommendation screen G3 does not display the urging information J12.

The second modification recommendation screen G3 displays urging information J13 urging to modify the setting of the meter 27, if notifications for the meter 27 are enabled, based on the occupant information 124 recorded in the occupant information DB 122. The urging information J13 includes a character string saying “Adjust the brightness of the meter 27”. If notifications for the meter 27 are disabled, the second modification recommendation screen G3 does not display the urging information J13.

The second modification recommendation screen G3 displays urging information J14 urging to modify the setting of the rearview mirror 29, if notifications for the rearview mirror 29 are enabled, based on the occupant information 124 recorded in the occupant information DB 122. The urging information J14 includes a character string saying “Adjust the angle of the rearview mirror”. If notifications for the rearview mirror 29 are disabled, the second modification recommendation screen G3 does not display the urging information J14.

Note that information for generating the urging information J12, J13, J14 based on the preference information 125 is prestored in the memory 120.

### 2. Operation

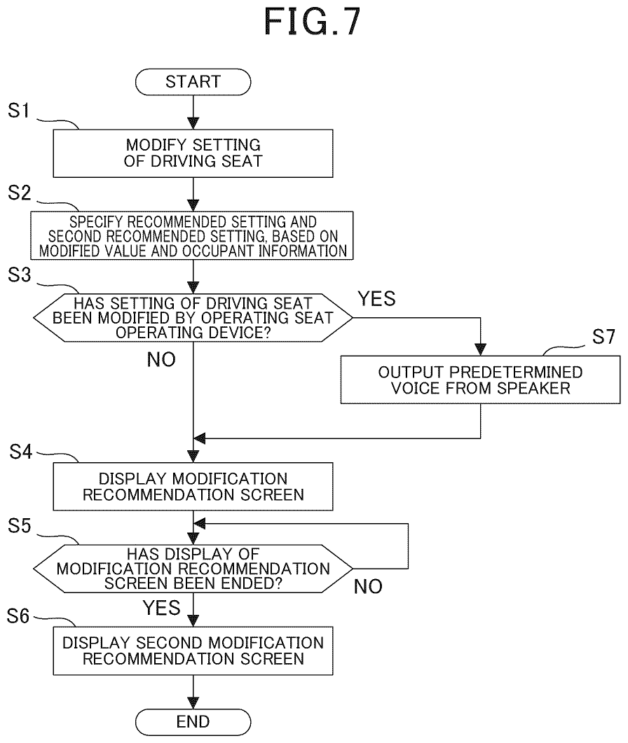

Next, a process related to notifications urging to modify the settings of equipment related to the driving seat 21, which is performed by the vehicle notification device 100 when a setting of the driving seat 21 is modified, will be described using FIG. 7.

FIG. 7 is a flowchart showing an operation of the vehicle notification device 100.

Before the operation shown in FIG. 7, the occupant identification unit 117 has already identified that a specific occupant P entered the vehicle, and the occupant information 124 linked to the occupant P on board has been acquired. Moreover, the seat modification unit 111 and the steering modification unit 112 have modified the settings of the driving seat 21 and the steering wheel 22, based on the driving position information 123 linked to the occupant P on board and acquired by the occupant identification unit 117.

First, the seat modification unit 111 modifies a setting of the driving seat 21 via an operation performed by the occupant P (step S1). Next, the setting specifying unit 115 specifies the recommended setting and the second recommended setting, based on the modified value resulting from modifying the setting of the driving seat 21 by the seat modification unit 111 in step S1 and the occupant information 124 (step S2).

Next, the seat modification unit 111 determines whether or not the setting of the driving seat 21 has been modified by the seat operating device 21A provided to the driving seat 21 (step S3).

When the seat modification unit 111 determines that the setting of the driving seat 21 has not been modified by the seat operating device 21A (step S3: NO), the notification unit 116 causes the display control unit 119 to display the modification recommendation screen G2 shown in FIG. 5 (step S4).

Next, the notification unit 116 determines whether or not to end the display of the modification recommendation screen G2 (step S5), and, if the display of the modification recommendation screen G2 is not to be ended (step S5: NO), the notification unit 116 repeats the determination in step S5 and the modification recommendation screen G2 continues to be displayed. As described above, the condition for ending the display of the modification recommendation screen G2 is when there is no input from the occupant P via the modification recommendation screen G2 for a predetermined time, or when the end button B23 is pressed.

When the display of the modification recommendation screen G2 is to be ended (step S5: YES), the notification unit 116 causes the display control unit 119 to switch the display from the modification recommendation screen G2 to the second modification recommendation screen G3 (step S6). Note that the second modification recommendation screen G3 disappears after being displayed only for a predetermined time, and is switched to a predetermined screen.

Thus, when the setting of the driving seat 21 is modified, a notification to urge the occupant P to modify the settings of the side mirror 23 and the steering wheel 22 that are related to the traveling of the vehicle 1 is given by displaying the modification recommendation screen G2. Next, after the modification recommendation screen G2, the second modification recommendation screen G3 is displayed only for the predetermined time and then disappears. By these operations, notifications urging to modify the settings of the side mirror 23 and the steering wheel 22, which are examples of specific equipment, are given with a higher priority than other equipment.

Returning to the description of step S3, when the seat modification unit 111 determines that the setting of the driving seat 21 has been modified by the seat operating device 21A (step S3: YES), the notification unit 116 causes the speaker 26 to output a voice urging the occupant P to look at the touch panel 25 (step S7). After the end of step S7, the process proceeds to step S4.

### Another Embodiment

The embodiment described above merely represents one aspect of the present invention, and any modification and application can be made.

In the above embodiment, the driving position information 123 includes information about settings of the driving seat 21 and the steering wheel 22 for each occupant ID, but is not limited to this. The driving position information 123 may further include information about the position and angle settings of the side mirror 23, the brightness, height and angle settings of the HUD 24, the brightness setting of the meter 27, the temperature setting of the air-conditioning device 41, the volume setting of the speaker 26, etc. In this case, when a specific occupant P enters the vehicle, the seat modification unit 111 modifies the setting of the driving seat 21, the steering modification unit 112 modifies the setting of the steering wheel 22, the mirror modification unit 113 modifies the setting of the side mirror 23, and the HUD modification unit 114 modifies the setting of the HUD 24, based on the driving position information 123. Moreover, an ECU (not shown) provided in the vehicle 1 executes control on modifying the setting of the meter 27, the temperature setting of the air-conditioning device 41, and the volume setting of the speaker 26.

The occupant identification unit 117 may be configured to function as a face authentication unit that identifies an occupant P by comparing a person's face image extracted from an image captured by the in-vehicle camera 28 with a face image recorded in advance in the occupant information DB 122 for each occupant P. The face image may be captured by an external camera installed on the outside of the vehicle 1, instead of the in-vehicle camera 28. The occupant identification unit 117 may also be configured to identify an occupant P, based on a user name selected by operating the touch panel 25 or the like, or based on the result of comparing an input password with a password recorded in association with a selected user name.

The occupant identification unit 117 may be configured to specify the occupant information 124, that is, information about the physique as an example of the features of the occupant P, from the image captured by the in-vehicle camera 28, and calculate the sitting height or the like. In this case, even when the occupant P is not recorded in the occupant information DB 122, the setting specifying unit 115 can specify, based on the occupant information 124 about the occupant P, the recommended settings and the second recommended settings. Such an occupant identification unit 117 corresponds to an example of the “occupant information specifying unit” that specifies the occupant information 124 about an occupant P who is not limited to specific occupants P.

The driving seat 21 may not have the seat operating device 21A, and may be configured to accept a setting modification made by the occupant P only from the operation screen G1. In this case, the notification unit 116 does not need to give notifications by voice.

Moreover, the driving seat 21 may be configured to accept a setting modification only from the seat operating device 21A, without accepting a setting modification made by the occupant P from the operation screen G1.

In the above-described embodiment, the steering wheel 22 is configured to include an adjustment mechanism capable of modifying the position and angle settings of the steering wheel 22, but is not limited to this. For example, the steering wheel 22 may not have the adjustment mechanism, and the vehicle notification device 100 may be configured without the steering modification unit 112.

The vehicle 1 may be configured without the HUD 24.

In the above-described embodiment, after the end button B23 on the modification recommendation screen G2 is pressed, the second modification recommendation screen G3 disappears after being displayed only for a predetermined time, but the operation is not limited to this. For example, the modification recommendation screen G2 may display the HUD selection button B6 for selecting a modification of the setting of the HUD 24. In this case, the HUD selection button B6 is displayed smaller than other mirror selection button B4 and steering selection button B5. Consequently, a higher priority is given to notifications urging to modify the settings of the side mirror 23 and the steering wheel 22.

The processor 110 may be constituted by a plurality of processors, or may be constituted by a single processor. The processor 110 may be hardware programmed to realize the above-described functional units. In this case, these processors may be configured, for example, by an application specific integrated circuit (ASIC) and a field programmable gate array (FPGA).

Moreover, the configuration of each unit in the vehicle notification device 100 shown in FIG. 2 is an example, and specific implementation forms are not particularly limited. In other words, it is not necessary to install hardware individually corresponding to each unit, and it is, of course, possible to achieve a configuration that realizes the functions of the respective units by one processor executing a program. Further, in the above-described embodiment, some of the functions realized by software may be realized by hardware, and some of the functions realized by hardware may be realized by software.

The operational step unit shown in FIG. 7 is divided according to the main processing contents, and the present invention is not limited by how the unit of processing is divided or named. The process may be divided into more steps depending on the processing content. Moreover, a single step unit may be divided to include more processes. Further, the order of steps may be changed as appropriate within a range not interfering with the spirit of the present invention.

### 3. Configurations Supported by Above Embodiments

The above embodiments support the following configurations.

### (Configuration 1)

A vehicle notification device including: a modification unit that modifies a setting of specific equipment that is equipment specifically determined in advance among equipment provided in a vehicle; and a notification unit that, when a setting of the specific equipment is modified, gives an occupant of the vehicle a notification urging to modify a setting of relevant equipment that is the equipment related to the specific equipment.

According to the vehicle notification device of configuration 1, it is possible to prevent the occupant from forgetting to modify the setting of the relevant equipment when the setting of the specific equipment is modified.

### (Configuration 2)

The vehicle notification device according to configuration 1, wherein the relevant equipment is the equipment subjected to deterioration in functionality for the occupant due to the modification of the setting of the specific equipment.

According to the vehicle notification device of configuration 2, by giving the occupant a notification to modify the setting of the relevant equipment subjected to deterioration in functionality due to the modification of the setting of the specific equipment, it is possible to make a change to achieve a cabin space environment desired by the occupant and prevent the occupant from forgetting to modify the setting of the relevant equipment.

### (Configuration 3)

The vehicle notification device according to configuration 1 or 2, including a setting specifying unit that, based on the degree of the modification of the setting of the specific equipment made by the modification unit, specifies a recommended setting for the relevant equipment corresponding to the degree of the modification of the setting of the specific equipment, wherein the notification unit notifies information about the recommended setting specified by the setting specifying unit.

According to the vehicle notification device of configuration 3, by specifying and notifying the recommended setting for the relevant equipment, based on the degree of the modification of the setting of specific equipment, it is possible to grasp the cabin space environment desired by the occupant.

### (Configuration 4)

The vehicle notification device according to any one of configurations 1 to 3, including an occupant information specifying unit that specifies occupant information about the occupant, wherein the setting specifying unit specifies the recommended setting for the relevant equipment, based on the degree of the modification of the setting of the specific equipment made by the modification unit and the occupant information about the occupant using the specific equipment specified by the occupant information specifying unit.

According to the vehicle notification device of configuration 4, by specifying and notifying a predetermined setting recommended for relevant equipment corresponding to the occupant information that varies depending on each occupant, it is possible to more easily grasp the cabin space environment desired by the occupant.

### (Configuration 5)

The vehicle notification device according to configuration 4, including a storage unit that stores the occupant information for each specific occupant who is the occupant specifically determined in advance, wherein the occupant information specifying unit identifies the specific occupant who is the occupant specifically predetermined in advance, and specifies the occupant information about the specific occupant by referring to the storage unit.

According to the vehicle notification device of configuration 5, since a predetermined recommended setting can be specified for the specific occupant prerecorded for the vehicle, it is possible to improve the accuracy of grasping the cabin space environment desired by the occupant.

### (Configuration 6)

The vehicle notification device according to any one of configurations 1 to 5, wherein, when the modification unit detects that a setting of the specific equipment has been modified by an operating device provided to the specific equipment, the notification unit gives the occupant a notification urging to modify a setting of the relevant equipment, via display means provided in the vehicle, and notification means different from the display means.

According to the vehicle notification device of configuration 6, even when a setting is modified via the operating device located at a place different from the display means, it is possible to easily convey a notification urging the occupant to modify a setting of the relevant equipment.

### (Configuration 7)

The vehicle notification device according to any one of configurations 1 to 6, including a display control unit that controls a display of the display means, and displays an operation screen for modifying the setting of the specific equipment and the setting of the relevant equipment.

According to the vehicle notification device of configuration 7, a setting of specific equipment and a setting of relevant equipment, which is recommended to modify the setting along with the modification of the setting of the specific equipment, can be modified on a single screen, thereby achieving good operability.

### (Configuration 8)

The vehicle notification device according to any one of configurations 1 to 7, wherein the notification unit gives notifications while prioritizing a notification urging to modify a setting of specific relevant equipment that is the relevant equipment specifically related to traveling of the vehicle driven by the occupant among the relevant equipment, over a notification urging to modify a setting of other than the specific relevant equipment.

According to the vehicle notification device of configuration 8, when giving notifications for relevant equipment, by giving priority to a notification for equipment related to traveling of the vehicle driven by the occupant, the occupant can more easily grasp a cabin space environment suitable for the occupant, especially from the perspective of smooth traveling of the vehicle.

### REFERENCE SIGNS LIST

1 . . . vehicle; 12 . . . louver (relevant equipment); 21 . . . driving seat (specific equipment); 21A . . . seat operating device (operating device); 22 . . . steering wheel (relevant equipment, specific relevant equipment); 23 . . . side mirror (relevant equipment, specific relevant equipment); 24 . . . HUD (relevant equipment); 25 . . . touch panel (display means); 26 . . . speaker (notification means); 27 . . . meter (relevant equipment); 28 . . . in-vehicle camera; 29 . . . rearview mirror (relevant equipment); 40 . . . communication device; 41 . . . air-conditioning device; 90 . . . mobile communication terminal; 100 . . . vehicle notification device; 110 . . . processor; 111 . . . seat modification unit (modification unit); 112 . . . steering modification unit; 113 . . . mirror modification unit; 114 . . . HUD modification unit; 115 . . . setting specifying unit; 116 . . . notification unit; 117 . . . occupant identification unit (occupant information specifying unit); 118 . . . update unit; 120 . . . memory (storage unit); 121 . . . control program; 122 . . . occupant information DB; 123 . . . driving position information; 124 . . . occupant information; 125 . . . preference information; 126 . . . feature information; G1 . . . operation screen; G2 . . . modification recommendation screen; G3 . . . second modification recommendation screen; and P . . . occupant.

1. A vehicle notification device comprising:
a modification unit that modifies a setting of specific equipment that is equipment specifically determined in advance among equipment provided in a vehicle; and
a notification unit that, when a setting of the specific equipment is modified, gives an occupant of the vehicle a notification urging to modify a setting of relevant equipment that is the equipment related to the specific equipment.

2. The vehicle notification device according to claim 1, wherein the relevant equipment is the equipment subjected to deterioration in functionality for the occupant due to the modification of the setting of the specific equipment.

3. The vehicle notification device according to claim 1, comprising a setting specifying unit that, based on a degree of the modification of the setting of the specific equipment made by the modification unit, specifies a recommended setting for the relevant equipment corresponding to the degree of the modification of the setting of the specific equipment, wherein
the notification unit notifies information about the recommended setting specified by the setting specifying unit.

4. The vehicle notification device according to claim 3, comprising an occupant information specifying unit that specifies occupant information about the occupant, wherein
the setting specifying unit specifies the recommended setting for the relevant equipment, based on the degree of the modification of the setting of the specific equipment made by the modification unit and the occupant information about the occupant using the specific equipment specified by the occupant information specifying unit.

5. The vehicle notification device according to claim 4, comprising a storage unit that stores the occupant information for each specific occupant who is the occupant specifically determined in advance, wherein
the occupant information specifying unit identifies the specific occupant, and specifies the occupant information about the specific occupant by referring to the storage unit.

6. The vehicle notification device according to claim 1, wherein, when the modification unit detects that the setting of the specific equipment has been modified by an operating device provided to the specific equipment, the notification unit gives the occupant a notification urging to modify the setting of the relevant equipment, via display means provided in the vehicle, and notification means different from the display means.

7. The vehicle notification device according to claim 6, comprising a display control unit that controls a display of the display means, and displays an operation screen for modifying the setting of the specific equipment and the setting of the relevant equipment.

8. The vehicle notification device according to claim 1, wherein the notification unit gives notifications while prioritizing a notification urging to modify a setting of specific relevant equipment that is the relevant equipment specifically related to traveling of the vehicle driven by the occupant among the relevant equipment, over a notification urging to modify a setting of other than the specific relevant equipment.
